(19) United States
(12) Patent Application Publication
(10) Pub. No.: US 2008/0267117 A1
(43) Pub. Date: Oct. 30, 2008

(54) METHOD AND SYSTEM FOR LINKING TO CONTENT AND SERVICES FOR A COMMUNICATION DEVICE

(76) Inventor: Donald S. Stern, Lexington, KY (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/739,644

(22) Filed: Apr. 24, 2007

(51) Int. Cl. H04Q 7/00

(52) U.S. Cl. 370/329

(57) ABSTRACT

Embodiments for a system and method for providing a user with access via a mobile terminal to content and services, provided by content and service providers, using a communication network are described. The mobile terminal can be a mobile phone terminal, a personal digital assistant (PDA), tablet or portable computer having a screen, a processor adapted to run one or more software applications, an input interface, and wireless communication functions adapted to connect the mobile terminal to the communication network. A user selects a selectable item displayed on the screen using the user interface. The selection of the selectable item activates a software application which composes a data packet having a format for sending to the associated content or service provider where the packet is processed and the action taken.

### CROSS-REFERENCE TO RELATED APPLICATIONS

This application is one of a set of related U.S. applications, the set including: FORMATTING AND COMPRESSION OF CONTENT DATA (Atty. Docket No. GHACK19.002AUS), filed on even date herewith); and MESSAGE PUSH WITH PULL OF INFORMATION TO A COMMUNICATIONS COMPUTING DEVICE (Atty. Docket No. GHACK19.003AUS, filed on even date herewith) all of which are incorporated by reference in their entirety.

### BACKGROUND OF THE INVENTION

1. Field of the Invention

The technical field of the invention is methods for connecting to a service, sending or acquiring data for mobile communication devices. An example of an application of the invention is for acquiring further information related to an advertisement displayed on a communication device. Another example of an application of the invention is enabling a reply to an e-mail to be sent from a mobile device.

2. Description of the Related Art

Content providers and service providers are constantly looking for more ways to generate revenue. One of the drivers for revenue generation is simply enabling more users to subscribe to the content providers and access their services more often by making it as convenient as possible for the user to access the service. In particular, making it easy to access the service from a mobile device enables a user to use the service more often and from any number of locations.

Another way of generating revenue and also enabling subsidizing of service costs, and hence attractiveness to more subscribers, is advertising. Currently a number of Internet based services such as news services and e-mail services are provided free to users/subscribers because these services can be provided profitably based on advertising revenue. Advertisements shown on the web pages or using pop-up windows entice users to visit the advertiser's web pages for further information, to purchase their products or services, often on-line, or to contact the advertiser, say by e-mail to obtain further information. A user can simply select a hyperlink by clicking on an image or button to open an advertiser's web page or obtain further information, the user can then simply use the browser functionality to go back to the original web page and continue whatever they were doing before their attention was diverted to the ad.

This has proved to be an effective advertising tool in the Internet domain. However, for use in a wireless or mobile domain where a user may not always be connected in an active communication session this form of advertising cannot be effectively used. There are a number of situations where a user may be viewing content on their mobile device but not be engaged in an active communication session over the wireless network, such as when a user is reading SMS (short message service) or MMS (multimedia messaging service) messages, or viewing content downloaded and stored on the mobile device memory. In such situations a conventional hyperlink selection to switch to view another web page cannot be done.

### SUMMARY OF THE INVENTION

According to one aspect there is provided a method of a mobile terminal:

displaying on a display of a mobile terminal one or more selectable items each associated with content or services provided by a content or service provider system via the Internet whereby a user can select a selectable item using an input interface;

activating a software application in response to the selection of a selectable item, which composes a data packet having a format defined to include all data to enable the content or service provider to deliver the content or service associated with the selectable item independent of a connection to the mobile terminal; and

sending the composed data packet to the content and service provider, via a communication session between the mobile terminal and a content or service provider server associated with the selected item, for processing the data packet by the content or service provider server to provide the content or services associated with the selected item.

According to another aspect there is provided a system enabling a mobile terminal to access content and services, provided by content and service providers via an Internet, the system comprising:

one or more mobile terminal software applications adapted to run on the mobile terminal processor whereby the mobile terminal is adapted to:
display one or more items selectable by a user using a mobile terminal input interface on a display, wherein each selectable item is associated with content or services provided by a content or service provider;
compose a data packet having a defined format including information to enable a content or service provider server to take action to provide the service independent of the mobile terminal; and
send the composed data packet via a communication session to the content and service provider server associated with the selected item; and

one or more content or service provider applications, whereby each content or service provider is adapted to:
receive a data packet sent by a mobile terminal;
process the data packet; and
take action to provide the content or services associated with the selected item.

Another aspect provides a method of linking to content or service providers, comprising. The method of this aspect includes displaying on a display of a mobile terminal one or more user selectable items each associated with content or services provided by a content or service provider via a network, the user selectable items being selectable using an input interface. The method further includes composing a data packet in response to a user selection of a selected item, the data packet comprising data to enable the content or service provider to provide the content or service associated with the selected item, and sending the composed data packet to the content or service provider via a first asynchronous communication session over the network. The method further includes receiving a first notification that the data packet has been received by the content or service provider via a second asynchronous communication session over the network, and receiving a second notification via a third asynchronous communication session over the network, the second notification indicating that the content or service provider has completed at least a portion of processing to provide the content or service associated with the selected item.

Another aspect provides a mobile terminal for linking to content or service providers. The mobile terminal of this aspect includes means for displaying one or more user selectable items each associated with content or services provided by a content or service provider via a network, the user selectable items being selectable using an input interface, means for composing a data packet in response to a user selection of a selected item, the data packet comprising data to enable the content or service provider to provide the content or service associated with the selected item, means for sending the composed data packet to the content or service provider via a first asynchronous communication session over the network, means for receiving a first notification that the data packet has been received by the content or service provider via a second asynchronous communication session over the network, and means for receiving a second notification via a third asynchronous communication session over the network, the second notification indicating that the content or service provider has completed at least a portion of processing to provide the content or service associated with the selected item.

Another aspect provides a computer readable medium comprising programming instructions that upon executing cause a machine to display one or more user selectable items each associated with content or services provided by a content or service provider via a network, the user selectable items being selectable using an input interface, compose a data packet in response to a user selection of a selected item, the data packet comprising data to enable the content or service provider to provide the content or service associated with the selected item, send the composed data packet to the content or service provider via a first asynchronous communication session over the network, receive a first notification that the data packet has been received by the content or service provider via a second asynchronous communication session over the network, and receive a second notification via a third asynchronous communication session over the network, the second notification indicating that the content or service provider has completed at least a portion of processing to provide the content or service associated with the selected item.

Another aspect provides a communication device for accessing content or services. The communication device of this aspect includes a display, an input interface, and a processor in electrical communication with the display device and the input interface, the processor configured to display one or more user selectable items each associated with content or services provided by a content or service provider via a network, the user selectable items being selectable using the input interface, receive an input from the user interface indicating a selected item, compose a data packet in response to the received input, the data packet comprising data to enable the content or service provider to provide the content or service associated with the selected item, send the composed data packet to the content or service provider via a first asynchronous communication session over the network, receive a first notification that the data packet has been received by the content or service provider via a second asynchronous communication session over the network, and receive a second notification via a third asynchronous communication session over the network, the second notification indicating that the content or service provider has completed at least a portion of processing to provide the content or service associated with the selected item.

Another aspect provides a system enabling a mobile terminal to access content or services over a network. The system of this aspect includes a mobile terminal comprising a display and a processor in electrical communication with the display, the processor being configured to display one or more user selectable items selectable by a user using an input interface, wherein each selectable item is associated with content or services provided by a content or service provider compose a data packet in response to a user selection of a selected item, the data packet comprising information to enable a content or service provider server to take action to provide the service or content associated with the selected item, and send the composed data packet via a first asynchronous communication session over the network to the content or service provider server associated with the selected item. The system of this aspect further includes a content or service provider server configured to receive the composed data packet, process the data packet, send a first notification that the data packet has been received via a second asynchronous communication session over the network and send a second notification that the data packet has been processed by the content or service provider to provide the content or services associated with the selected item via a third asynchronous communication session over the network.

Another aspect provides a method for enabling a mobile terminal to access content or services over a network. jThe method of this aspect includes displaying one or more user selectable items selectable by a user using an input interface, wherein each selectable item is associated with content or services provided by a content or service providerj, composing a data packet in response to a user selection of a selected item, the data packet comprising information to enable a content or service provider server to take action to provide the service or content associated with the selected item, and sending the composed data packet via a first asynchronous communication session over the network to the content or service provider server associated with the selected item. The method of this aspect further includes receiving the composed data packet, processing the data packet, sending a first notification that the data packet has been received via a second asynchronous communication session over the network, and sending a second notification that the data packet has been processed by the content or service provider to provide the content or services associated with the selected item via a third asynchronous communication session over the network.

Another aspect provides a system for enabling a mobile terminal to access content or services over a network. The system of this aspect includes means for displaying one or more user selectable items selectable by a user using an input interface, wherein each selectable item is associated with content or services provided by a content or service provider, means for composing a data packet in response to a user selection of a selected item, the data packet comprising information to enable a content or service provider server to take action to provide the service or content associated with the selected item, means for sending the composed data packet via a first asynchronous communication session over the network to the content or service provider server associated with the selected item, means for receiving the composed data packet, means for processing the data packet, means for sending a first notification that the data packet has been received via a second asynchronous communication session over the network, and means for sending a second notification that the data packet has been processed by the content or service provider to provide the content or services associated with the selected item via a third asynchronous communication session over the network.

The user's mobile terminal can be any handheld or portable device which combines computing and networking functions. For example a cellular telephone (that operates on any cellular network), a personal digital assistant (PDA), a smart communications computing device, portable personal computer (PC), tablet computer, palm top device, handheld device, wireless email devices, wireless communication devices, such as the RIM Blackberry, wirelessly coupled computer systems (laptops, desktops, etc.), computer systems connected over a wired link, satellite devices that receive data over a satellite link or other device that combines a handheld or portable device combining computing and networking functions.

Content throughout this specification refers to information available as data from an electronic source and can include rich content such as available from an internet web site including graphically formatted textual information, images, animations, video and audio data. Content can also include information enabling accessing of further content such as links, URLs, or forwarding address information.

An event refers to any action which may be used to trigger the forwarding of content data to a user, such as when new content becomes available, time based events or triggering events, such as a calendar reminder or a periodic information update. Examples of events where information becomes available include breaking news, a score in a game, or receipt of an e-mail.

Throughout the following specification render and rendering is used to refer to the reproducing or displaying the content as the content provider intended to the content to be perceived by the user on the user's equipment. For example rendering the content includes but is not limited to reproduction of audio signals as sound output by device speakers, the display of visual images on a display screen and the display of animated content as moving images on the display screen.

### BRIEF DESCRIPTION OF THE DRAWINGS

Embodiments, incorporating aspects, will now be described by way of example only with reference to the accompanying drawings in which:

FIG. 1 illustrates examples of selectable items displayed on a mobile device screen.

FIG. 2 illustrates the method of embodiments.

FIG. 3 is an example of accessing content or services from the mobile device according to an embodiment.

FIG. 4 is an example of processing performed by a content provider to provide content to a mobile device using an event alert and delivery system according to an embodiment.

FIG. 5 is an example of using an event alert and delivery system for the mobile device to receive requested content.

FIG. 6 is an example of sending an e-mail through an e-mail service provider in accordance with an embodiment.

FIG. 7 illustrates a log on procedure for an instant messaging service provided using an embodiment.

FIG. 8a, b & c illustrate an instant messaging dialogue using an embodiment.

FIG. 9 illustrates an example of an embodiment used in a call queuing application.

### DETAILED DESCRIPTION OF THE INVENTION

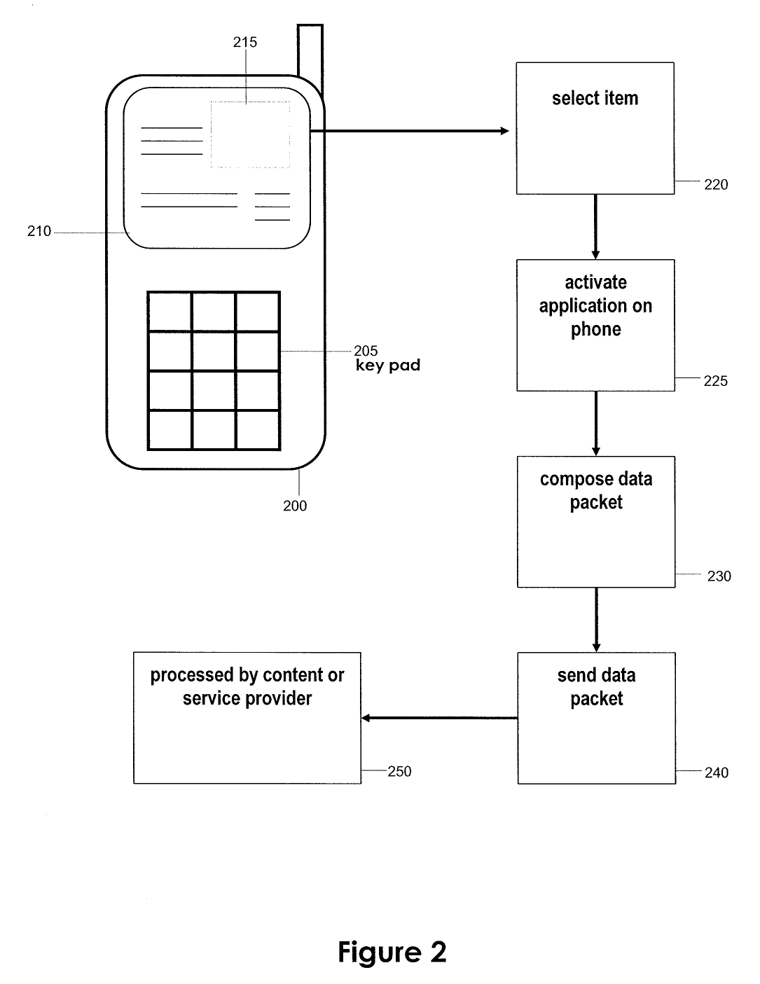

Embodiments provide a system and method for providing a user with access via a mobile terminal to content and services, provided by content and service providers, using a communication network, an overview of the process is illustrated in FIG. 2. The mobile terminal 200 can be a mobile phone terminal, a personal digital assistant (PDA), tablet or portable computer having a screen, a processor adapted to run one or more software applications, an input interface, and wireless communication functions adapted to connect the mobile terminal to the communication network. A user selects a selectable item 215 displayed on the screen 210 using the user interface 205. The selection 220 of the selectable item 215 activates a software application 225 which composes 230 a data packet having a defined format for sending 240 to the associated content or service provider 250 where the packet is processed and the action taken.

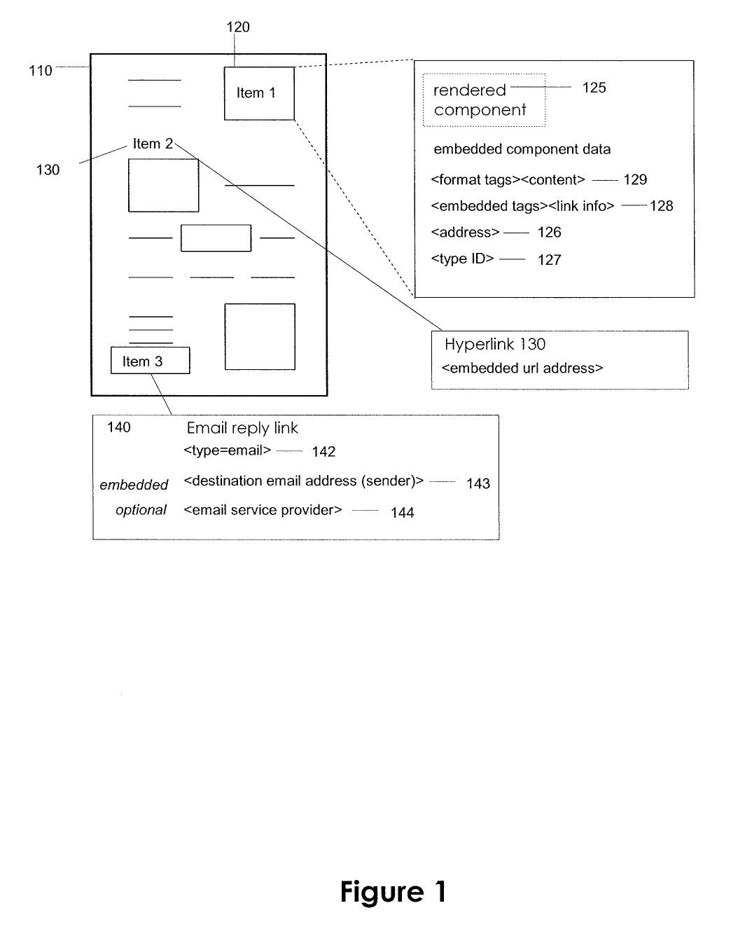

FIG. 1 illustrates some examples of selectable items 120, 130, 140 displayed on the screen 110 of a mobile device. Each selectable item 120, 130, 140 is associated with content or services provided by a content or service provider. The selectable item may visibly identify the content or service provider, for example, as shown in FIG. 1 selectable item 130 is the address or URL for the content provider's web site, or include embedded information which is not rendered visible to the user but is used by an application running on the processor of the mobile device to identify the content source. For example, as shown in FIG. 1 selectable item 120 comprises a renderable component which in this example is an image to display to the user, and an embedded component which includes data identifying the content source address 126, and an identifier for the linked content 127, the embedded content can also include information such as properties for the displayed image 129 or an internal link 128 to another area or item within the whole displayed document. The embedded data can be structured using a defined format or tags such as XML tags.

It is not necessary for the actual content or service provider address to be included in the embedded content, provided there is sufficient information for the application running on the mobile device to use to determine the appropriate content or service provider. For example, selectable item 140 is an e-mail reply link, and the embedded information includes the type of item 142 “e-mail” and details of the e-mail sender 143, however, the address of the e-mail service provider 144 may already be known, say defined as a user setting in the device and identifiable based on the type of item, so in this case the e-mail service provider address need not be included in the embedded data. In an alternative example an identifier which enable the appropriate address to be looked up or otherwise determined can be used, say a selectable item related to an instant messaging (IM) service then the service may be identified using an identifier such as “Yahoo” which enables the application to look up the IM service provider address and users account information out of a table of IM service providers subscribed to by the user.

The application running on the mobile terminal can also use embedded information to determine what action is being requested, so it is not necessary for a user to specify the action, when the item is selected the mere selection of the item determines the action which is to be performed. For example the embedded information may include a type indicator identifying the action requested as a data acquisition request, e-mail enquiry, open an IM chat, send an SMS, call a telephone number, etc. Alternatively, the type of action may be specified by the user, say by which button is pressed when selecting the item, for example an e-mail may have the options of REPLY, REPLY TO ALL, or FORWARD which can be selected by pressing buttons “1” “5” or “9” respectively.

The data packet to be sent to the content or service provider has a defined format. The format may be identical for any action or there may be some variation in the format for different actions, for example using a defined format for each type of action, or including and omitting optional elements. In some embodiments the packet format is substantially identical for all action types with the only variation being the inclusion or omission of optional elements dependent on the action type and independent of the packet destination. This enables a common packet format to be used for all actions and destinations, simplifying the processing performed by the mobile terminal to prepare the packet, which, in turn, minimizes the application footprint in the device memory and reduces the processing power. Further, applications or clients for executing the action are not required on the mobile device.

Once the data packet is composed, a communication session is opened between the mobile terminal and the content or service provider associated with the selected item and the data packet is sent to the content and service provider. The content or service provider processes the received data packet and takes action to provide the content or services associated with the selected item. The steps executed by the content or service provider are dependent on the action.

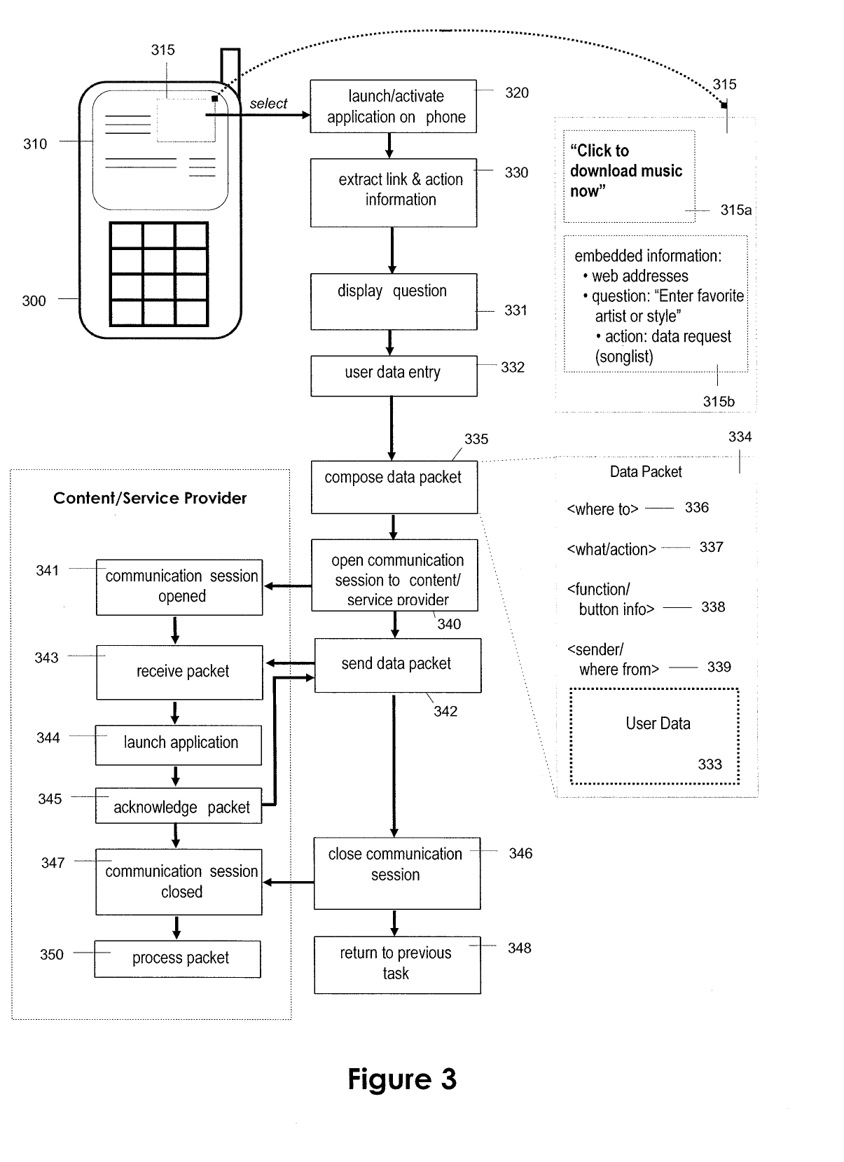

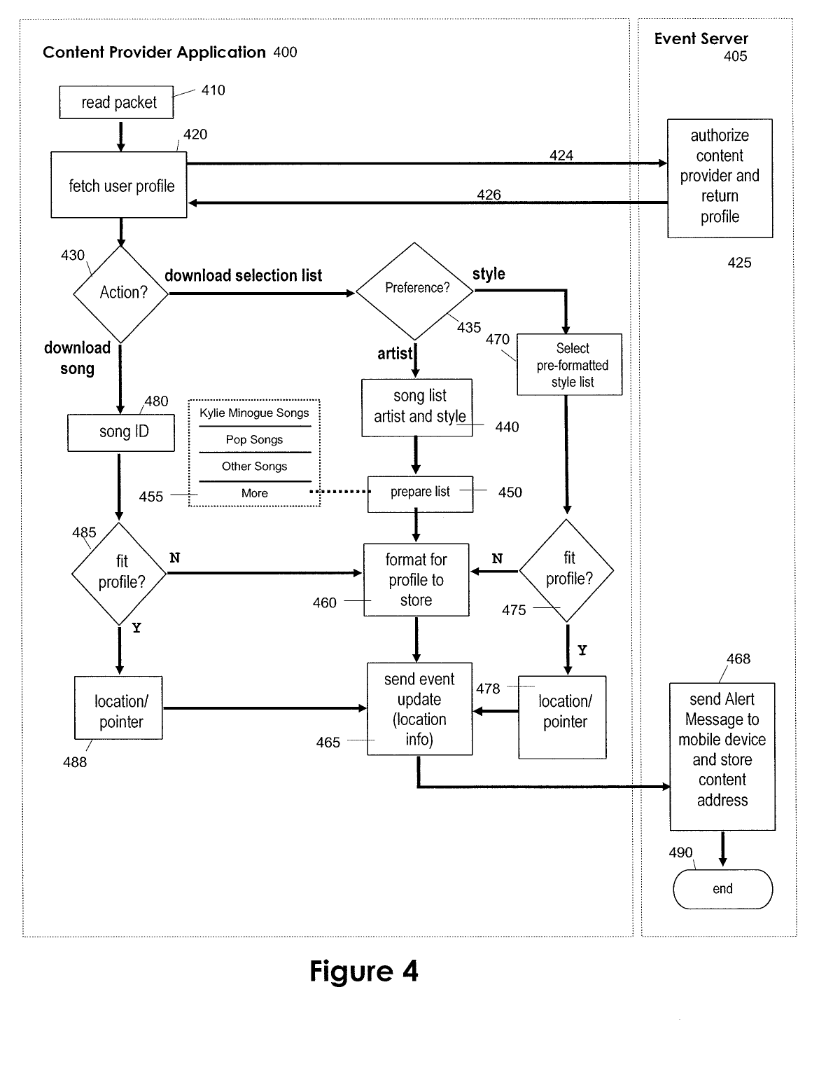

An example where the selected item is an advertisement will now be discussed in further detail with reference to FIGS. 3 and 4. In this example content is displayed on the screen 310 of a mobile device 300 and an advertisement 315 is a selectable item within that content. The advertisement 315 has a rendered component 315a which is the advertising image enticing the user to click the image to receive further information, and an embedded component 315b which contains information including the web address of the advertiser, the action type “data request—song list” and in this example an optional question to be answered by the user “what is your favorite music style or artist?”. The advertisement 315 is an invitation to download music with video clips to the user's mobile device, the question in the embedded data is designed to obtain information from the user regarding their music preferences in order to provide a list of preferred songs for the user, for example by artist or style. Use of such a question is optional. When the user selects the advertisement 315, this launches or activates an application 320 for processing the request and composing a data packet to be sent to a content or service provider. The application reads 330 the embedded component 315b of the selected advertisement 315 and from the embedded information determines that the action to be taken is a data request, that there is a question to be asked to the user, and address of the content provider, to be used for sending the data packet. The application then causes the question “What is you favorite music style or artist?” to be displayed 331 on the screen for the user. This question may appear in a window with a free text field to be used for the user to enter their reply 332, so the user can enter their preference, for example “R&B” or “Kylie Minogue”. Alternatively instead of using a question a lit of preference options may be included as part of the rendered advertisement image, for example the image could include selection options such as “press 1 for POP, 2 for Rock, 3 for R&B, 4 for Metal, and 5 for Jazz” so the user preference can be determined from the key pressed to select the advertisement. Where there is only one possible outcome, such as only one song advertised, for example “Download Kylie's latest hit video!”, then it is not necessary to include a preference question or selection options.

The application composes 335 a data packet 334 to be sent to the content provider. The data packet 334 comprises a packet header identifying the packet destination address 336, the action to be taken on receiving the packet 337, and sender information 339 identifying the user device generating the packet. The header can also contain optional information, such as identifying the button used to select the item, for example buttons 1-5 indicating the user's preference from a displayed list. The packet body 333 contains the data entered by the user in response to the displayed question, again this body is optional depending on whether any user data was entered or not.

Once the packet is composed, a communication session is opened between the mobile device 340 and the content provider 341, for example the communication session can be an Internet protocol (IP) communication session. The data packet is then sent 342 to the content provider. The mobile device closes 346 the communication session after the data packet is sent 342 and returns to the previous task 348, such as displaying the document. Optionally the mobile terminal may wait to receive an acknowledgement from the content provider of the packet reception before closing the communication session, if an acknowledgement is expected by not received the mobile device application may resend the data packet or simply close the communication session and provide an error message to the user.

Reception of the data packet 343 by the content provider causes an application to be launched or activated 344 in the content provider's equipment for processing the data packet and taking the appropriate action. Optionally once this application has been launched it may send an acknowledgement 345 to the mobile terminal. The communication session is closed 347 by the mobile terminal. The content provider application then proceeds to process the data packet 350.

It is desirable to leave the communication session between the mobile terminal and the content provider open for as short a time as possible to minimize the risk of the communication session being hacked into or unwanted/unsolicited communication, such as spam or pop-ups being sent to the mobile device using the open communication session, this can also minimize costs, for example where there is a charging component based on the duration of the communication session. Further, where a mobile carrier charges the user for the amount of data downloaded, the user will be charged for the data whether it is solicited or not, so the user could be charged for receiving spam if the communication session is left open. However, when the action is a request for data to be downloaded to the mobile device, the problem is how to securely re-connect to the content server to download the requested data once the content provider has processed the data packet.

An embodiment enables the user to re-connect to the content provider in a controlled and secure manner, by using an mediator system such as an event alert and delivery system to remove a lot of the functionality used to verify the connection and control the content from either the mobile device or the content provider. For example, an appropriate event alert system is described in a co-pending patent application number claiming priority from United States of America provisional patent application No. 60/810,769 entitled “Message push with IP pull of information to a communication computing device” filed on Jun. 2, 2006, which is incorporated by reference in its entirety.

The event alert system can be used to notify a user through their mobile device that an event for which they have subscribed to receive information has occurred and perform validation checks to ensure that the user only received event update alert messages for events a user has subscribed to from a source authorized by the user. The user's device is adapted to automatically respond to such event alert messages and open a communication session between the user's device and the content provider to acquire the data directly from the content provider. The event alert system mediates the providing of content to a user's device to ensure that only messages related to authorized events from authorized content providers are forwarded to the user's device. Thus, a communication session between a user's device and a content provider will only be opened for the specific purpose and the duration of time required for acquiring the data associated with the authorized event, then the connection is closed to minimize any risk of hacking or spam to the user's device and also minimize the use of wireless network resources and conserve battery power on a target mobile device.

If the application is still running and an alert message is received, the alert maybe identified as being generated due to the content request. In this case any currently displayed content can be removed from the screen and replaced with the content or advertising newly retrieved in response to the alert message. This can be done by encoding the request to the server with a code that is returned when the new content is available in front of other queued and pending content or advertising that is waiting to be displayed.

In an alternative embodiment once an information request is sent the device may exit the currently displayed content and wait for the new content delivery to re-trigger the display, thus, saving battery power used to display content on the device screen.

An example of the process used by a content provider for processing the data packet and enabling the data download using an event alert and delivery system is illustrated in FIG. 4.

The content prover 400 reads the data packet at step 410, the data packet includes a user identifier, such as a phone number, e-mail address or other identifier, which is used to send in an message 424, such as an event update message, to an event server 405 of an event alert and delivery system. As this message is generated from a user request for further information the request is pre-authorized by the user, so an authentication process for the content provider is not required. The type of message may indicate the pre-authorization or an item in the message may convey the pre-authorization, such as an authorization code or key. An authorization code or key may be common for all pre-authorized messages, common for all pre-authorized messages from a particular content or service provider, common to all pre-authorized messages related to one user device or vary for each message or periodically. The authorization code may be a temporary code, use encryption or have some other security feature to inhibit the code being maliciously re-used either by the content provider or another party intercepting the message 424. For example, an authorization key may be a mobile device generated key that is valid for the single content access and the return of the content or advertisement to the device.

When the message 424 is received by the event server, the event server takes whatever steps 425 are necessary to recognize the pre-authorization of the content provider by the user and return the user's device profile to the content provider 426. The content provider then determines the action to be performed 430. For this example the action is downloading a list of songs for the user to choose from. In this example the user could indicate their preference either by artist or style, the preference used is determined in step 435. If the user has given a style preference, a pre-prepared song list for the chosen style can be used. A number of different copies of the pre-prepared song list may be stored by the content provider which each copy being formatted for a type of mobile device, for example the same list of song may be stored 5 times with each copy being formatted for a different phone of the 5 most popular mobile devices either on the market or used by the content providers subscribers. For example, the most popular devices can be determined from market research information or logging of the devices used by actual content provider users and subscribers. Alternatively the content provider could simply store a copy of every list which has been requested and formatted for a particular device, so if a previous user, having the same device profile as the current user, has requested the list the this formatter version will be used again for the current user. To prevent an excessive number of lists being stored the content provider may employ any number of management strategies. For example, a content provider may store a maximum of ten different format copies of any one list, therefore catering for up to ten different device profiles at any one time for a particular music style. When a user having a profile different from the ten catered for profiles requests a copy of the list, the least recently used preformatted list can be deleted and replaced with a newly formatted list for the current user. In this example the lists formatted for the most popular user device profiles would be most likely downloaded more often than those having less popular profiles, therefore it is more likely that a less popular profile is the least recently used list.

Alternatively, depending on the content, a version of the content may be stored formatted for all or the majority of possible target devices. For advertisements this preformatted content cache can be used to reduce the overhead on the server of on demand converting and formatting the advertising. Advertising may be downloaded often for many different target devices, for example where the advertising is appended to other content. Having preformatted versions of the advertising content allows faster access to the content. This is particularly suitable for advertising content because once the advertisement is completed it will not change and can therefore become static.

If a song list exists which is pre-formatted for the user's device, based on the device profile 475, then the pointer or address of this list is returned 478 for sending to the event sever 405 in an event update message 465 so that the event server sends a message to the mobile device to trigger the mobile device to fetch the song list 468.

If a song list is not already preformatted for the user device profile, then the step of formatting the song list 460 is executed and the pointer, to where the newly formatted song list is stored, returned for sending to the event server 465.

If the user has provided and artist preference the content provider performs a search on the requested artist in step 440 and prepares a song list in step 450. In this example the list prepared by searching the entire song catalogue for songs by the requested artist, Kylie Minogue, which are placed first in the list, these may be presented in any order determined by the content provider, for example ordered by latest hits, greatest hits, by album or alphabetically.

Optionally the list may also include other songs, not by the requested artist but say the latest hits for the music style of the selected artist, in this case POP hits, then other songs such as the current top 10 downloads, the way the list is composed can be determined by the content provider. An option at the end of the list to look at more song titles, which would initiate a further song list request may also be added. The size of the list composed can be based on the user device profile, for example limiting the list to a number of songs based on the device memory or the number of songs which can be displayed on say five screens. Alternatively the song list may be of a set length determined by the content provider based on market research or user feedback, for example twenty songs.

Once the list has been composed 450, the list is formatted 460 for the particular user's device using the device profile and stored by the content provider. A pointer to the stored list is returned for sending to the event server 465.

Optionally the content provider may also check for whether an already prepared list exists, which may be the case for a new hit artist or group and if necessary formats this list in accordance with the user device profile and returns the pointer for this list.

The pointer to the content, in this case the song list, is forwarded 465 in an event update message to the event server 405, with information identifying the user to fetch the content and optionally user pre-authorization information, such as an authorization code discussed above. The event update message causes the event server 405 to send an alert message 468, such as an SMS message, to the user's device in accordance with an alert and delivery process, to enable the user's device to open a communication session and directly access the song list, using the content provider supplied pointer, from the content provider's server.

The communication session may remain open while the user views the song list, so that a song can be downloaded directly via the open communication session, or the communication session can be closed once the song list is downloaded so the user views the list without an open network connection also referred to as OFF LINE. If the user is viewing the song list OFF LINE and selects a song to download, then a data packet is composed by the application running on the user's device, as described above with reference to FIG. 3, identifying the user and the song and is sent to the content provider to request the song.

When the data packet requesting the song is received 410 the step 420 of requesting the user profile and providing pre-authorization for the content data request in performed again, such that the song request is treated as a new and separate action to the previous request for the song list. In some embodiments this step may be omitted if information regarding the ongoing content request is maintained by the content server and the event server, however, this adds complexity to the applications of the content provider and event servers for tracking ongoing transactions, and also may increase the risk of hacking into the ongoing transaction, for example by intercepting an authorization code which is used throughout the transaction.

The action to be performed 430 is a song download. The content provider uses song identification information, such as a song identification code, location or tile from the data packet to look up the song and any preformatted copies 480 and checks whether there is a version of the song and video pre-formatted for the user's device profile, if this is the case a pointer to the pre-formatted version is returned, otherwise the song and video data is reformatted based on the profile of the user's device, stored and the pointer to the newly formatted version returned. If the user is still ON LINE, then the requested song and video data cab be downloaded directly, otherwise the pointer to the song and video data is sent 465 to the event server in order to generate another alert message 468 enabling the user to open a communication session to directly download the appropriately formatted song and video once they receive the alert message via the event alert and delivery system.

The opening, closing and re-opening of the communication session between the user's device and the content or service provider can be made invisible to the user, by the application running on the user's device. Thus, to the user it appears as if the transaction or dialogue between the user and the content or service provider is being performed ON LINE. However, in fact while there is no data being transmitted, for example while the user is looking at the list of songs, the communication session is closed to avoid exposing the device to unsolicited data transfer or viruses and minimize costs. Further, using an event alert and delivery system means that all communication sessions between the user device and content or service provider are opened by the user device, so the content provider does not need to attempt to connect to a mobile device to open a communication session, which is barred by most mobile carriers to avoid misuse such as spam.

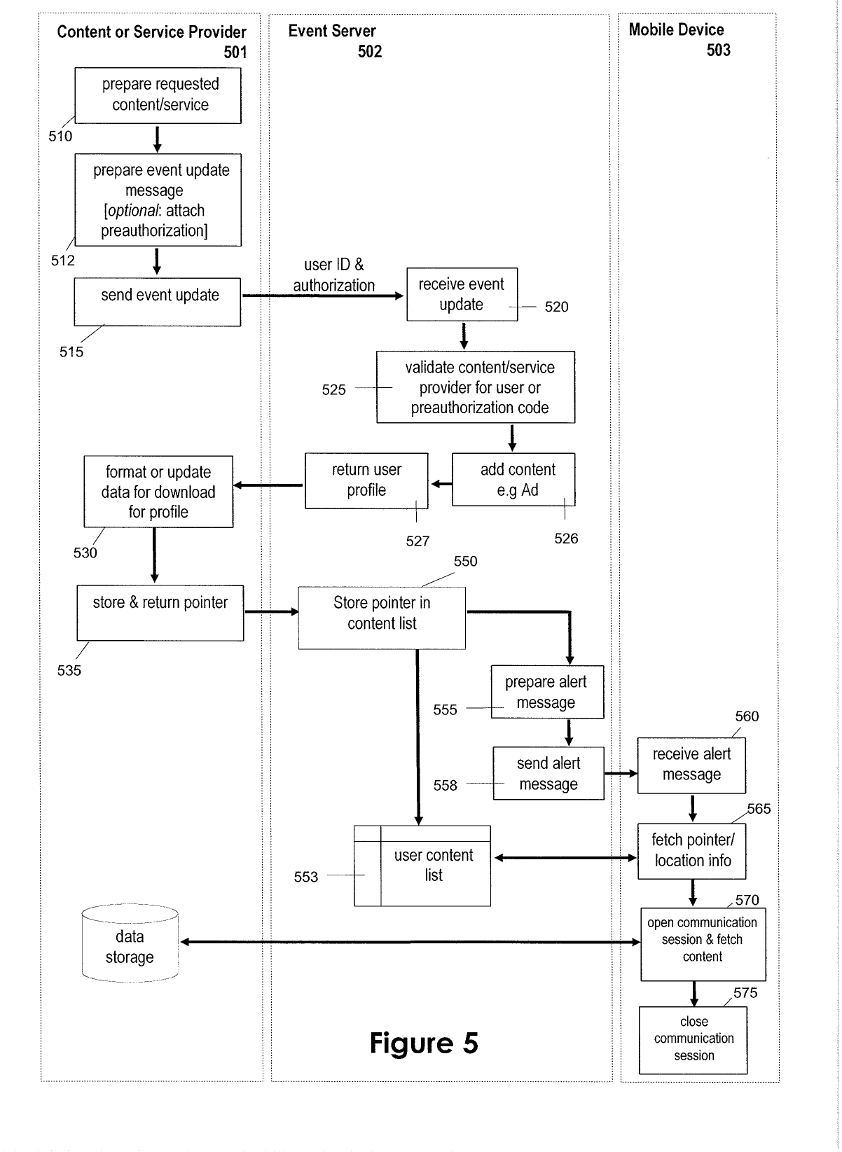

An example of the interaction between a content or service provider 501, event alert and delivery service provider 502, and the mobile device 503 is illustrated in FIG. 5. The content or service provider 501 prepares the content, for example the song list in step 510. The content provider then prepares an event update message including user identification information in step 512, this event update message can also include an authorization code or key, or some other indicator used to inform the event alert and delivery service that the user has requested the content delivery. For example, where the content or service provider is recorded as an authorized content or service provider for the user in the event alert and delivery system, such as an e-mail service provider or news update source, then an authorization code will not be required. Where the content or service provider is a source the user has not previously authorized or subscribed to, for example where the user has responded to an advertisement to request further information, the event message will be rejected as originating from an unauthorized source if a valid authorization code, key or other indicator of the users request for the information is not provided. The event update is then sent 515 to the event alert and delivery service 502.

The event update message is received 520 by the event alert and delivery service 520 and the event update validated 525. The validation can include checking whether the content or service provider is authorized for the user. Alternatively, if an authorization code or key is included in the event update message then the event update and delivery service can check whether this code is valid.

After the event update is validated 525 the user profile 527 is sent back to the content or service provider. Optionally additional information 526, such as a advertisement or message can also be sent to the content or service provider to be incorporated in or appended to the data to be downloader by the user.

The content or service provider can then check whether the data is appropriately formatted for the user's device and if necessary re-format the data and add any additional data, such as further advertising 530. The data for download by the user is then stored, say in a file server or database 540 and the location information, such as a pointer or address of the data for use by the user when fetching the data is returned 535. The content or service provider then forwards the location information, along with any other information necessary such as the user identification and authorization code or key, to the event alert and delivery service provider 502.

The event alert and delivery service provider 502 stores the location information in a content list 553 for the user 550, or inserts the location information into an event alert message 555. The event alert message is a message such as an SMS which will be forwarded to the user's mobile device via the communication network in a way that does not require the mobile device to fetch the message, but rather that the message will be pushed to the user's mobile device. The alert message is prepared 555 and sent 558 to the user's mobile device 503.

Reception of an alert message 560 by a user's mobile device 503 cause an application on the users device to, if necessary, open a communication session to the event alert and delivery service provider server to fetch location information 565 from the content list 553, this communication session is then closed. If the location information is included in the event alert message, then this step is omitted. The application on the mobile device then opens a communication session 570 between the mobile device 503 and the content or service provider equipment 501 using the provided location information to directly fetch the requested data from where it is stored 540 in the content or service provider equipment 501. Once the data is fetched the communication session to the content or service provider can be closed 575 to minimize the risk of hacking or spam, and minimize the consumption of battery power and communication network resources.

In the above example the application on the mobile device automatically connects to the content or service provider to acquire the data without requiring input from the user, so it will appear to the user as if the content has been sent directly to the user by the content or service provider. However, the application on the mobile device can also be programmed to alert the user when an alert message is received and wait for the user to perform an action, such as push a button, before opening the communication session to the content or service provider and acquiring the data.

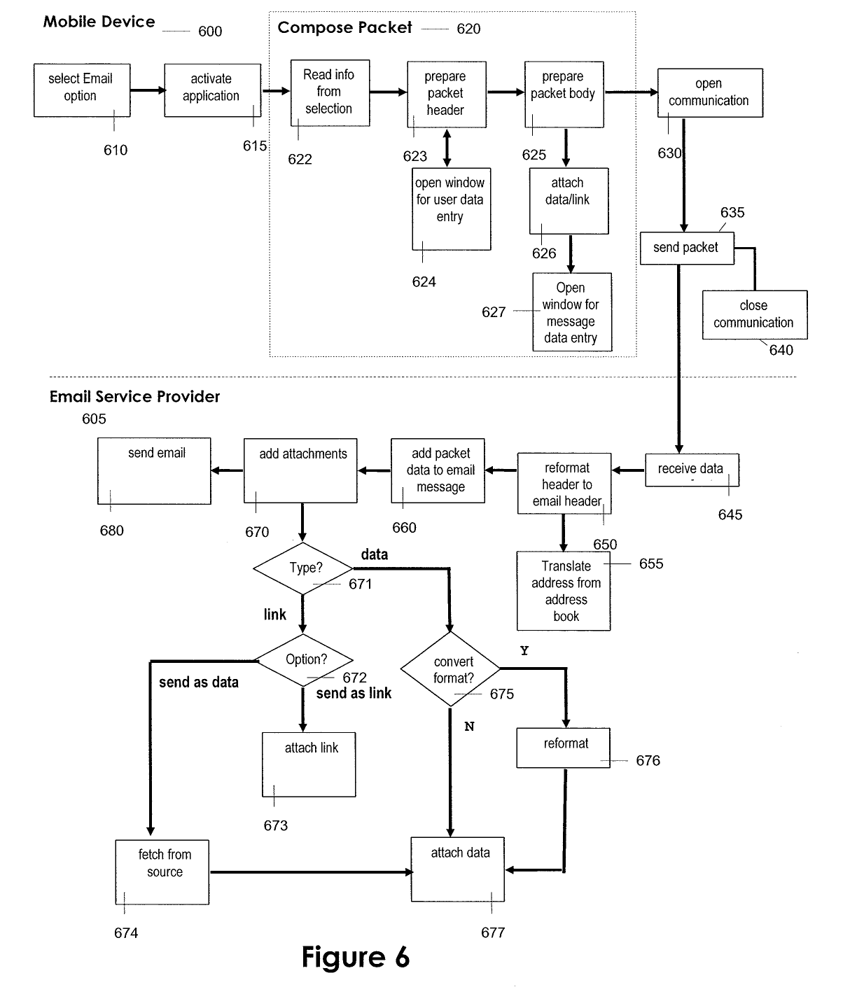

Embodiments can be used to provide messaging services without the need to provide a message client on the mobile device. For example, as illustrated in FIG. 6 an embodiment can be used for sending an e-mail from a mobile phone without requiring an e-mail client on the mobile phone. A user selects an e-mail sending item 610 displayed on their mobile phone 600, for example, sending an e-mail may be displayed as an option:
1. for an address book item, where the options may be to call the person, send an SMS, or send an e-mail;
2. for selecting an item from displayed content, such as “receive further information via e-mail” or for a news article “e-mail this article”; or
3. for content generated from the phone, such as a photograph of a new pet or a video or audio clip of a group singing happy birthday to an absent friend, once this content is stored in phone memory the user could be provided with options such as “store”, “erase” or “e-mail to friend”.

The selecting of an e-mail option 610 causes an application on the mobile phone to be activated 615 to compose 620 a data packet for sending to the e-mail server. Firstly the application reads any information available from the e-mail selection step 622, for example this may include the destination address if the e-mail option is chosen from an address book, embedded data associated with an item selected from displayed content, or a pointer to locating in the phone memory where a photograph is stored. The application prepares the data packet header 623 and message data 625 using the read information and additional information added by the application such as the return e-mail address for the user or entered by the user.

While preparing the data packet header the application can open a window 624 on the screen asking for further information from the user to compose the header, for example the destination e-mail address or a contact reference to enable the application to select the destination e-mail address from a phone book, if the destination address is not known.

The data for the body of the data packet includes information regarding any attachments and the e-mail message text. The attachments 626 can be included as a link, where the attachment resides on a content provider server, such as a copy of a news article, or the entire attachment data can be included in the message body, for example where the attachment is a photograph taken using the phone. The application can be adapted to determine whether the attachment data resides only on the phone or whether the attachment is derived from content downloaded to the phone and thus able to be retrieved form the actual content source.

Opening windows or using query screens can be used to enter e-mail message text 627. The message text is then incorporated in to the body of the data packet.

Once the data packet is composed 620 a communication session is opened 630 by the phone to the e-mail service provider server. To open this communication session the phone can use a service provider address stored in the phone memory or provided as part of the information read when the e-mail item is selected, for example where several e-mail service providers are enabled for the user. Once the data packet is sent 635 to the e-mail service provider 605, the communication session is then closed 640.

The content receives the data packet 645 for processing by an application running on the e-mail server 605 to convert the data packet into an e-mail format and send the e-mail. The application reformats the data packet header information into an e-mail header 650. This can include a step of looking up a destination address 655, for example if the destination is given in the data packet header as an identifier, pointer or nickname from an address book for an individual or group, the application can look up the address book for the full e-mail addresses. Once the e-mail header is prepared the e-mail body is prepared by inserting the message text from the data packet 660 and adding any attachments 670.

Adding attachments 670 can involve a number of steps. The type of attachment information is first check 671 to determine whether the attachment included in the data packet is the actual attachment data, such as a photograph, or a link to the attachment data such as an Internet address for the attachment data. Where the actual attachment data is included, the service provider can determine 675 whether the data is in a suitable format which can simply be attached to the e-mail as a data file 677, or whether the data file requires conversion. For example the data may require conversion 676 from a format suitable for the mobile device, for example a high compression format that may require a specific or proprietary application to open, to a generic file format which is more likely to be compatible with the receiver's equipment, for example JPEG, bitmap, or TIFF format. The converted attachment data file is then attached to the e-mail 677.

Where the attachment information is a link, then the application determines 672 whether the user has nominated to send the attachment as a link, in which case the link is attached 673, or as data which triggers the application to fetch the attachment data from the content source using the link 674 and attaches a copy of the fetched attachment as a data file to the e-mail 677. Alternatively where the action is to forward an e-mail to another user, this may be indicated as a link such that the e-mail service provider attaches the copy of the original e-mail from the user's e-mail account to the new e-mail. The e-mail is then sent 680. It should be appreciated that the processing of the data packet performed by the e-mail service provider, converts the data packet from a format optimized for transmission by the mobile device into a standard e-mail format.

Sending messages, such as e-mails, SMS or MMS messages, is a one way transaction, rather than a dialogue, say using an instant messaging service, which is a two way transaction. A dialogue or two way transaction requires not only a message being sent from the user's mobile device to another party, but also expects a response back to the user from the other party. For an instant messaging service the processing of the messages from the mobile user to the instant messaging (IM) service provider can be performed in a similar manner to the e-mail example above, and the IM service provider using an event alert and deliver service for delivering response messages back to the user in real time, which, in turn, avoids the need to maintain an open communication session between the user and the IM service provider for the duration of the IM dialogue.

The event alert and delivery service can also be used during a log on or presence updating process, for the user and also to alert the user to changes in presence status of their friends, who are other parties the user has invited to share instant messages with them. For example, a user's presence information, enabling others to determine whether they are available to receive instant messages or not, is maintained by the instant messaging service. When a user is connected to the Internet on a PC they can log on to an instant messaging service and while they remain connected to the Internet and logged on to the IM service their presence information will show them as available for receiving messages. Further they can see which of their friends are also available. In a mobile environment where the user is not always connected user can log on to the IM service to indicate they are available and the IM service use an alert and delivery system to alert the user to any incoming massages and trigger the user to connect to the IM server to retrieve the instant message. Similarly the event alert and delivery system can be used to notify the user or any change in the presence information of their friends, for example a friend logging ON or OFF the IM service. The friend presence information can be retained in the mobile device memory while they too are logged onto the IM service and automatically updated in response to the event alert and delivery system messages as described above.

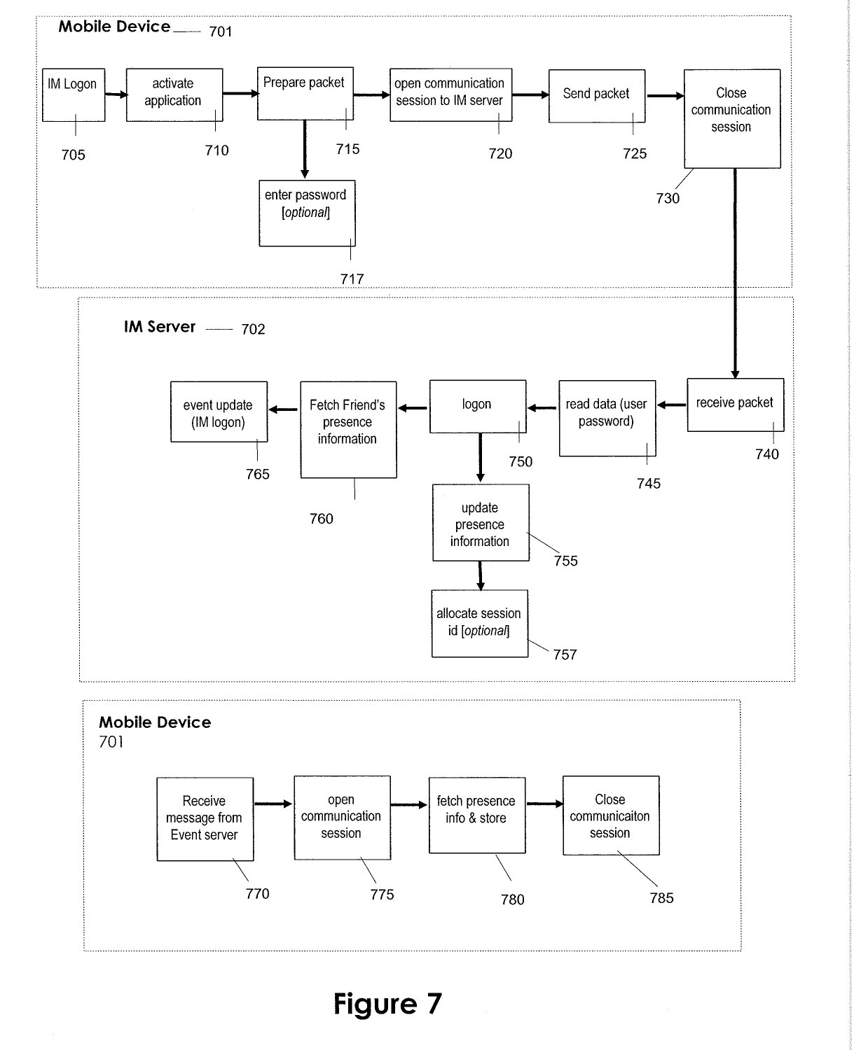

An example of logging on to an IM service using a mobile device will now be described with reference to FIG. 7. The user can select the IM logon 705 option displayed on their mobile device, for example by selecting IM logon from a displayed menu. Selecting the IM logon option causes an application on the mobile device to be activated 710 to compose a data packet 715 for sending to the IM service provider to perform the log on. The data packet can have a defined format and the application can be adapted to automatically insert the user's IM identifier and password into the packet. Alternatively the user can be asked to enter their password 717 each time they wish to log on. To minimize the steps required to be performed by the user the IM service provider address can be stored in the device memory and automatically used by the application when the IM option is selected. Once the data packet is composed a communication session is opened 720 between the user's device 701 and the IM service provider server 702, the data packet sent 725 to the IM service provider, and the communication session closed 730.

Receiving the data packet 740 from the user's mobile device causes an application running on the IM server to process the data packet and perform the log on. The application reads information such as the user's identifier and password from the data packet 745 and uses this information to log the user onto the IM service 750. The log on can include updating the user's presence information 755, so the user appears as logged on to the system and available to receive messages to the user's IM friends. The log on can also include allocating a session identifier or authorization code if necessary, for example an authorization code may be issued for use by an event server identify that the user is logged on and therefore authorizing any IM to be forwarded to their mobile device.

Once the user has been logged on to the IM service, the application can fetch presence information for the user's friends 760 and prepare and send an event update 765 to an event alert and delivery system. The event update message causes an event alert message to be sent to the mobile device, when this message is received 770 by the mobile device the mobile device opens a communication session 775 to the IM server to receive confirmation of the log on and fetch presence information 780 for the user's friends. The communication session is then closed. If the presence information for any of the user's friends' changes, for example a friend logs onto the IM service, the IM service can similarly generate an event update to cause the user's device to connect to the IM server and receive the updated presence information.

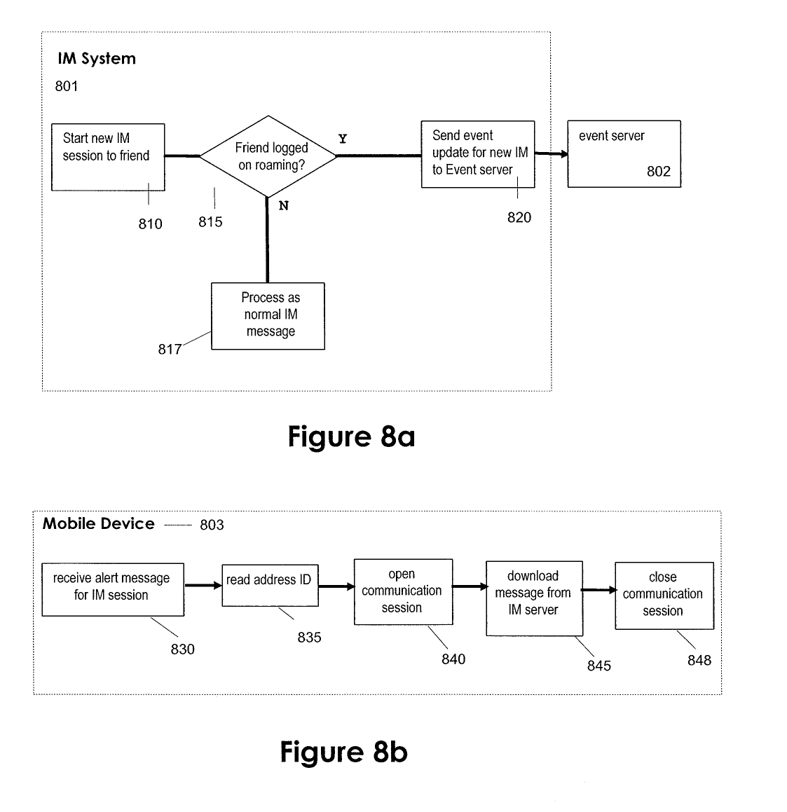

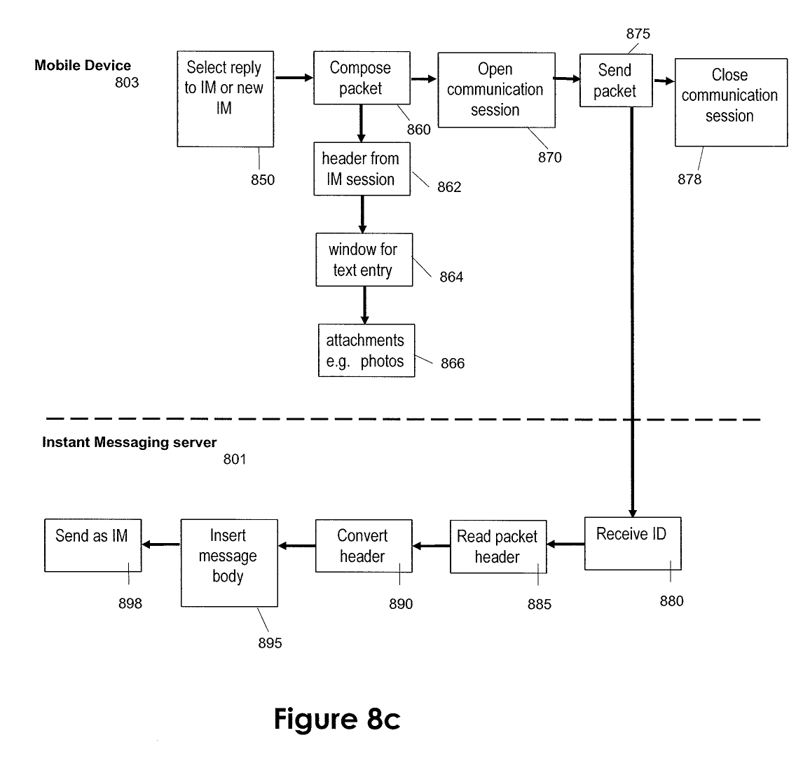

The event alert and delivery service can also be used to cause the mobile device to connect to the IM server in the case of an incoming IM message to the user. As is illustrated in FIG. 8a, an IM to the mobile user is composed 810 by a friend using the IM service 801. The IM server 801 checks whether the mobile user is logged on in from their mobile device 815, for example a roaming log in, or whether they are logged in normally, say on a PC. For the roaming mode the IM server stores the message, say in a file server in the IM service equipment, and prepares and sends an event update 820 to an event alert and delivery service 802. The event update includes identification information for the user's device can also include location information for the stored message, alternatively the location information for the message con be fetched by the event server after the initial event update. Optionally the message is re-formatted and compressed, optimized for downloading by the mobile device. The event alert and deliver service confirms the IM service is an authorized content source for the user, reads the location information for the stored message and sends an alert message to the user's mobile device 803 to cause the mobile device 803 to connect to the IM server to retrieve the message.

An example of the mobile device 803 retrieving an IM message from the IM service is illustrated in FIG. 8b. On reception of the alert message 830 by the mobile device 803 an application is activated on the mobile device 803 to read the alert message. If the address of the IM message stored on the IM file server is provided in the alert message, the mobile device can open a communication session 840 connect directly to the IM file server. Otherwise, the mobile device can open a communication session to the event server to read the message address from the user's content list 835. The mobile device then opens a communication session 840 directly to the IM file server and downloads the IM message data 845 for display on the mobile device. Optionally the communication session my remain connected while the message is displayed and the user may send a reply to the IM message directly to the IM server while connected to the IM server before closing the communication session 848.

In a preferred embodiment the communication session between the IM server and the mobile device is closed 848 after the message data is acquired 845 by the mobile device, such that the display of the message and any response message by the user will be prepared OFF LINE. An example of the process for replying to an IM message in this embodiment is illustrated in FIG. 8c. A user either selects an option to send a new IM or reply to an IM 850 from their mobile device 803, an application in the mobile device composes a data packet 860 having a header 862 generated using information from the IM message being replied to, such as the reply address, IM message indicator, user identifier, or entered by the user, such as the destination for a new IM. The application opens a window or field to enable the user to enter text for the body of the message 864 and also add attachments such as photographs 866.

Once the data packet is composed the application opens a communication session 870 between the mobile device 803 and the IM server 801 for sending the composed data packet 875 to the IM server. Optionally while this communication session is open, information such as presence information for the user and the user's friends may be updated. For example if the user has initiated a new IM session, the sending of this message may also cause the user to be logged on to the IM server, rather than the log on being performed separately by the user. The communication session between the mobile device 803 and the IM server 801 is closed 878 after the IM is sent 875.

The IM server 801 receives the data packet 880 and an application on the IM server reads the destination from the data packet header 885, and converts the packet header into the appropriate IM format 890 and inserts the IM message body from the body of the data packet into the IM message 895, the IM message is then sent to the destination 898 and handled as a regular IM message.

Embodiments of the invention can also be used for connecting phone calls. For example, embedded information associate with a selectable item can include a phone number, which the application on the mobile device could be programmed to dial directly using a telecommunication network, or connect to a server such as a voice over IP server (VoIP) to connect a call.

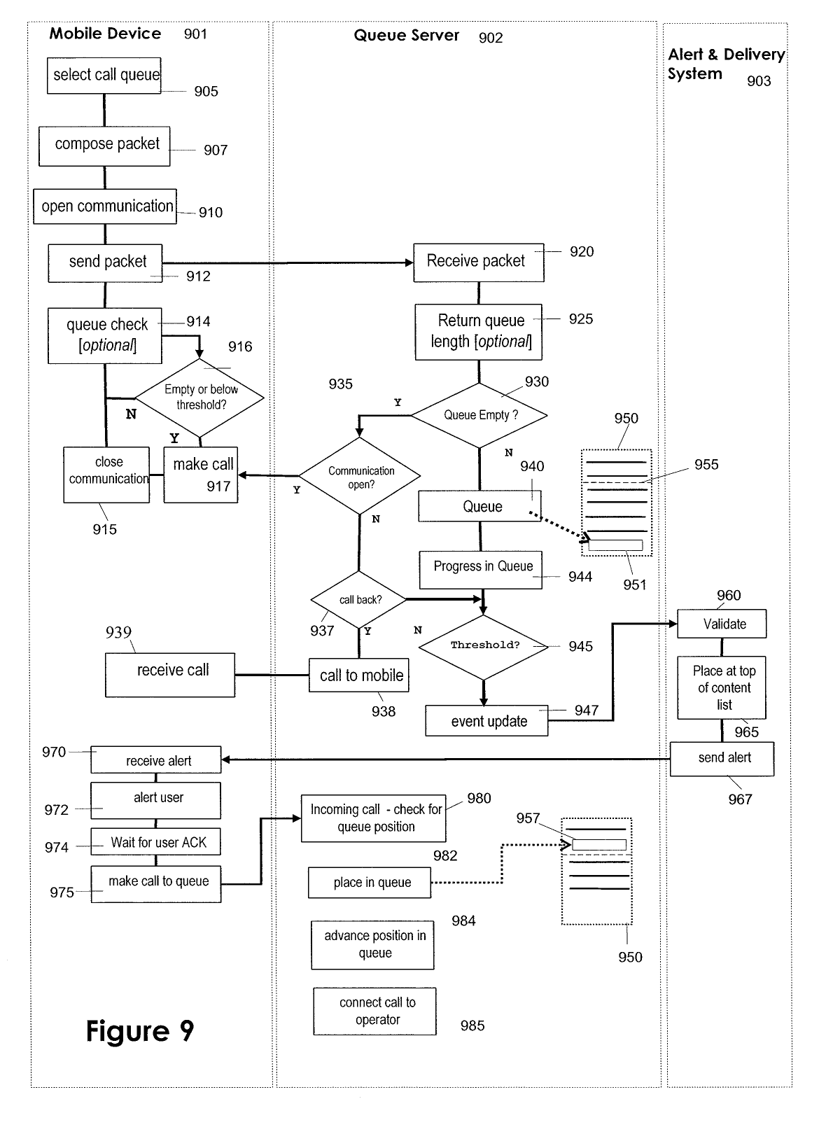

Embodiments of the present invention can also be utilized for situations where phone calls are likely to be placed ON HOLD in a call queuing system until a call centre operator is available to take the call. For mobile phone calls generally a call is billed in blocks of minutes or seconds, in some cases every second of a call is billed. Therefore it is desirable to avoid waiting ON HOLD for a mobile terminal. In the example illustrated in FIG. 9, a selectable item displayed on the users mobile device 901 has embedded information indicating a call connection request through a call centre, such as an option to select the item to contact an insurance or utility company by call back or OFF LINE queuing where a queue position is reserved for the mobile user when they first contact the call queuing system and an alert and delivery system is used to alert the user to make an actual call connection once their reserves position progresses to a threshold position in the queue. For example, the embedded information can include the address of a call queuing system and the action to be taken is placing the user in the queue to connect to an operator. When the user selects the call queue item 905, an application on the mobile device composes a data packet 907 using the embedded information. A communication session 910 is opened from the mobile device 901 to the call queuing server 902 indicated in the embedded information. The data packet is sent 912 to the queue server 902 and the communication session is closed 915. The queuing server can also be adapted to send back an alert and delivery message to update the user with information such as their queuing identifier, their reserved place in the queue, anticipated wait time or other items to help the user. The user can also cancel the queue by again selecting a field in the queue message display and posting a queue cancel message.

Optionally the application in the mobile device can be programmed to wait for a confirmation or call queue length check before closing the communication session. For example, after receiving data packet 920 the queue server 902 may be adapted to return 925 a queue length value or a flag indicating whether the length of the queue empty or below a threshold level, for example less than 3 calls currently in the queue. If the queue length value or flag indicated the queue is short or empty 916, the mobile device can proceed to connect the call directly 917, for example using VoIP using the current communication session, or close the communication session automatically dial the phone number to connect the call via the telecommunication network. The options used depend on the functionality of the call queuing system and the mobile device, preferences or allowed actions for the call queuing system can be defined in the embedded information in the selectable item used to establish the connection to the queue server.

The data packet is received 920 by an application running in the call queuing server 902 and this application recognizes from the information in the data packet that a call back or OFF LINE call queuing has been requested. The length of the queue is checked 930. If the communication session between the mobile device and the queue server remains open, the application can optionally return a queue length value or flag 925, as discussed above. Alternatively, if there are no calls currently waiting in the queue, or the queue is not longer than a threshold number of calls then, if the communication session is open 935, the queue server can indicate to the mobile device that the call can be connected immediately for example using VoIP and the current communication session. If there is no current communication session between the mobile device and the queue server, then the queue server takes whatever action is necessary to connect the call. For example, if the service is a call back service, then the queue server will dial the number of the mobile device to connect the call 938. If the queue service uses an event alert and delivery system to trigger the mobile user to call the service when they reach the top of the queue, the queue service will compose and send an event update message 947 to the event alert and delivery service server. The phone number dialing can be hidden from the user as the application can make the call automatically using the phone's wireless or VOIP routing to connect the call.

If the queue is not empty 930, then the queue server application records the user's identification information and any necessary additional information, such as an authentication code, and reserves a place 951 in the queue 950 for the user 940. The reserved place 951 will be at the end of the queue 950 when it is first reserved. As calls are answered 942 the position of the user's call reservation 951 progresses 944 towards the front of the queue 950. Each progression 944 the application in the queue server checks 945 whether a call reservation has reached a threshold position 955 in the queue 950, for example third place in the queue. When the reservation has progressed in the queue to the threshold 955 the queue server application will that the action necessary to cause the call to be connected. Where the queue is a call back queue 937, the queue server or an operator will dial the number to call the user's mobile device 938.

Where the system is an OFF LINE queuing system, the queue server will generate an event update 947 for sending to the alert and delivery system 903 to, in turn, trigger a phone call to be connected to the queue server by the mobile device. The event update includes information such as the address or identifier of the user's reservation in the queue and, if necessary, the authentication code. The event update is received and validated 960 by the event alert and delivery system 903, for example the validation can include checking an authentication code for the user or the queue service. The information required for the user's device to establish a call to the queue will then be placed at the top of the user's content list 965, so it will be the next item fetched, and an alert message is sent to the user 967. Alternatively information such as the queue telephone number or the queue location and user's queue identifier can be sent directly to the user in the event alert message.

When the event alert message is received by the user's mobile device 970, the application in the user's mobile device can be programmed to immediately take action to connect a call to the queue 975 or to alert the user 972 and wait 974 for confirmation be the user before taking action to connect the call.

To connect the call 975 the application in the mobile device either directly calls a number, or makes a VoIP connection to an address provided in the event alert message, or connects to the alert and delivery system to obtain information from the content list and then connects the call.

When the queue server receives an incoming call from the mobile device 980, an application in the queue server compares the incoming phone number with queue reservations to find the place in the queue for the incoming call 982. The call in placed in the queue and optionally an announcement indicating the call queue position played for the user 984. For example, “Your call is 1^{st} in the queue and will be answered by the next available operator.” The call is then answered in due course by an operator 985. If the user's reservation is first in line in the queue then the call may be connected directly to an operator without having to wait in the queue at all.

In some embodiments the application in the mobile device may open a communication session to the queue server to ensure that the queue reservation has not expired before attempting to connect a call using the telecommunication network. For example, once a queue reservation reaches the threshold and the alert is sent the user may be allowed only a certain period of time, for example 5 minutes, to make the call back before the reservation expires. Alternatively, if the reservation has reached the top of the list the registration may expire if the user has not made a call by the time the next operator is available or reservation may expire after being skipped by a queuing system specified number of connected calls once it reaches the top of the list. If the registration expires, then a call to the queue server may be connected to an automatic announcement notifying the user that their queue reservation has expired and offering for a further reservation to be made, say by pressing a specified number on a telephone key pad.

In another embodiment the time out for such as queue service may be maintained by the event server, by placing a time out or expiry time on items in the content list. Once a time out is reached the item could be removed from the content list and replaced with a time out indicator or the location information in the list be changed to direct the user to a standard time out message.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

What is claimed is:

1. A method of linking to content or service providers, comprising:
displaying on a display of a mobile terminal one or more user selectable items each associated with content or services provided by a content or service provider via a network, the user selectable items being selectable using an input interface;
composing a data packet in response to a user selection of a selected item, the data packet comprising data to enable the content or service provider to provide the content or service associated with the selected item;
sending the composed data packet to the content or service provider via a first asynchronous communication session over the network;
receiving a first notification that the data packet has been received by the content or service provider via a second asynchronous communication session over the network; and
receiving a second notification via a third asynchronous communication session over the network, the second notification indicating that the content or service provider has completed at least a portion of processing to provide the content or service associated with the selected item.

2. The method of claim 1, further comprising retrieving information in response to receiving the second notification via a third asynchronous communication session over the network.

3. The method of claim 1, further comprising closing the first asynchronous communication session once the data packet is sent.

4. The method of claim 1, wherein the data packet format is substantially identical for any content or service.

5. The method of claim 1, wherein the selectable item comprises embedded information used for identifying the associated content or service provider.

6. The method of claim 5, wherein the embedded information comprises an identifier used to look up the content or service provider address.

7. The method of claim 5, wherein the embedded information further includes information identifying one or more actions to be taken by the associated content or service provider subsequent to receiving the composed data packet.

8. The method of claim 7, further comprising the user directing the content or service provider as to which of the one or more actions to take by selecting the selectable item.

9. The method of claim 8, wherein the input interface is a key pad and the user selects the one or more actions to be taken by pressing one or more predefined keys.

10. The method of claim 7, wherein composing the data packet further comprises the user entering data for the packet body using the input interface.

11. The method of claim 10, wherein the action associated with the selectable item is sending an e-mail or message and the data entered by the user includes text data for the e-mail or message body.

12. The method of claim 11, wherein the data entered by the user further includes data identifying an attached data file or link to a data file accessible via the Internet.

13. The method of claim 10, wherein the content or service provider is an e-mail or message service provider, the method further comprising the email or message service provider asynchronously processing the data packet by reformatting the data packet with appropriate e-mail or message format and sending the data packet to a destination address.

14. The method of claim 1, wherein the selected item is associated with a dialogue action wherein further communication between the content or service provider and the mobile terminal occurs.

15. The method of claim 14, wherein an action associated with the selected item comprises acquisition of content data, the method further comprising opening a communication session between the mobile terminal and the content provider and attempting to retrieve the data from a source address associated with the selected item, before composing and sending a data packet to request the content data if the attempt to retrieve the content data fails.

16. The method of claim 1, wherein the composed data packet comprises one or more of a packet header identifying, a destination address, an action to be taken upon receiving the packet, sender information, user device identifying information, information identifying a button used to select the selected item, and data entered by the user in response to a displayed question.

17. The method of claim 1, wherein the at least one of the first and second notifications is a short messaging service (SMS) or multimedia messaging service (MMS) message.

18. A mobile terminal for linking to content or service providers, comprising:
means for displaying one or more user selectable items each associated with content or services provided by a content or service provider via a network, the user selectable items being selectable using an input interface;
means for composing a data packet in response to a user selection of a selected item, the data packet comprising data to enable the content or service provider to provide the content or service associated with the selected item;
means for sending the composed data packet to the content or service provider via a first asynchronous communication session over the network;
means for receiving a first notification that the data packet has been received by the content or service provider via a second asynchronous communication session over the network; and
means for receiving a second notification via a third asynchronous communication session over the network, the second notification indicating that the content or service provider has completed at least a portion of processing to provide the content or service associated with the selected item.

19. A computer readable medium comprising programming instructions that upon executing cause a machine to:
display one or more user selectable items each associated with content or services provided by a content or service provider via a network, the user selectable items being selectable using an input interface;
compose a data packet in response to a user selection of a selected item, the data packet comprising data to enable the content or service provider to provide the content or service associated with the selected item;
send the composed data packet to the content or service provider via a first asynchronous communication session over the network;
receive a first notification that the data packet has been received by the content or service provider via a second asynchronous communication session over the network; and
receive a second notification via a third asynchronous communication session over the network, the second notification indicating that the content or service provider has completed at least a portion of processing to provide the content or service associated with the selected item.

20. A communication device for accessing content or services, comprising:
a display:
an input interface;
a processor in electrical communication with the display device and the input interface, the processor configured to:
display one or more user selectable items each associated with content or services provided by a content or service provider via a network, the user selectable items being selectable using the input interface,
receive an input from the user interface indicating a selected item;
compose a data packet in response to the received input, the data packet comprising data to enable the content or service provider to provide the content or service associated with the selected item;
send the composed data packet to the content or service provider via a first asynchronous communication session over the network;
receive a first notification that the data packet has been received by the content or service provider via a second asynchronous communication session over the network; and
receive a second notification via a third asynchronous communication session over the network, the second notification indicating that the content or service provider has completed at least a portion of processing to provide the content or service associated with the selected item.

21. The communication device of claim 20, wherein the processor is further configured to retrieve information associated with the processed data packet via a third asynchronous communication session over the network.

22. A system enabling a mobile terminal to access content or services over a network, the system comprising:
a mobile terminal comprising a display and a processor in electrical communication with the display, the processor being configured to:
display one or more user selectable items selectable by a user using an input interface, wherein each selectable item is associated with content or services provided by a content or service provider;
compose a data packet in response to a user selection of a selected item, the data packet comprising information to enable a content or service provider server to take action to provide the service or content associated with the selected item; and
send the composed data packet via a first asynchronous communication session over the network to the content or service provider server associated with the selected item; and
a content or service provider server configured to:
receive the composed data packet;
process the data packet;
send a first notification that the data packet has been received via a second asynchronous communication session over the network; and
send a second notification that the data packet has been processed by the content or service provider to provide the content or services associated with the selected item via a third asynchronous communication session over the network.

23. The method of claim 22, wherein the mobile terminal processor is further configured to retrieve information in response to receiving the second notification via a third asynchronous communication session over the network.

24. The system of claim 22, wherein the mobile terminal processor is further configured to close the first asynchronous communication session after the composed data packet is sent.

25. The system of claim 22, wherein the selected item comprises embedded information used for identifying the associated content or service provider.

26. The system of claim 25, wherein the embedded information further includes information identifying one or more actions to be taken by the associated content or service provider subsequent to receiving the composed data packet.

27. The system of claim 26, wherein the user directs the content or service provider as to which of the one or more actions to take by selecting the selectable item.

28. The system of claim 27, wherein the input interface is a key pad and the user directs the one or more actions to be taken by pressing one predefined key when selecting the selectable item.

29. The system of claim 22, wherein the mobile terminal processor is further configured to compose the data packet to include data entered by the user using the input interface.

30. The system of claim 29, wherein the action associated with the selectable item is to send an e-mail or message and the data entered by the user includes text data for the e-mail or message body.

31. The system of claim 30, wherein data entered by the user further includes data identifying an attached data file or link to a data file accessible via the Internet.

32. The system of claim 31, wherein the content or service provider is an e-mail or message service provider and the content or service provider server is further configured to reformat the data packet with appropriate e-mail or message format and to send the data packet to a destination address.

33. The system of claim 22, wherein the selectable item is associated with a dialogue action wherein further communication between the content or service provider server and the mobile terminal occurs.

34. The system of claim 33, wherein an action associated with the selected item is acquisition of content data and the mobile terminal processor is further configured to open a communication session between the mobile terminal and the content provider and attempt to retrieve the data from a source address associated with the selected item, before composing and sending the data packet to request the content data.

35. The system of claim 22, wherein the composed data packet comprises one or more of a packet header identifying, a destination address, an action to be taken upon receiving the packet, sender information, user device identifying information, information identifying a button used to select the selected item, and data entered by the user in response to a displayed question.

36. The system of claim 22, wherein at least one of the first and second notifications is an short messaging service (SMS) or multimedia messaging service (MMS) message.

37. A method for enabling a mobile terminal to access content or services over a network, the method comprising:
displaying one or more user selectable items selectable by a user using an input interface, wherein each selectable item is associated with content or services provided by a content or service provider;
composing a data packet in response to a user selection of a selected item, the data packet comprising information to enable a content or service provider server to take action to provide the service or content associated with the selected item; and
sending the composed data packet via a first asynchronous communication session over the network to the content or service provider server associated with the selected item;
receiving the composed data packet;
processing the data packet;
sending a first notification that the data packet has been received via a second asynchronous communication session over the network; and
sending a second notification that the data packet has been processed by the content or service provider to provide the content or services associated with the selected item via a third asynchronous communication session over the network.

38. A system for enabling a mobile terminal to access content or services over a network, the system comprising:
means for displaying one or more user selectable items selectable by a user using an input interface, wherein each selectable item is associated with content or services provided by a content or service provider;
means for composing a data packet in response to a user selection of a selected item, the data packet comprising information to enable a content or service provider server to take action to provide the service or content associated with the selected item;
means for sending the composed data packet via a first asynchronous communication session over the network to the content or service provider server associated with the selected item;
means for receiving the composed data packet;
means for processing the data packet;
means for sending a first notification that the data packet has been received via a second asynchronous communication session over the network; and
means for sending a second notification that the data packet has been processed by the content or service provider to provide the content or services associated with the selected item via a third asynchronous communication session over the network.
